(19) United States
(12) Patent Application Publication
(10) Pub. No.: US 2018/0096429 A1
(43) Pub. Date: Apr. 5, 2018

(54) SECURITIES TRADING MANAGEMENT SYSTEM

(71) Applicant: NOMURA RESEARCH INSTITUTE, LTD., Tokyo (JP)

(72) Inventors: Mitsuhiro Tsunoda, Tokyo (JP); Hideaki Ohtsubo, Tokyo (JP); Shunosuke Kajimoto, Tokyo (JP); Yoshichika Hashimoto, Tokyo (JP); Takahiro Tanaka, Tokyo (JP); Yuichiro Shimokaji, Tokyo (JP); Shigenari Fukui, Tokyo (JP); Takashi Ozeki, Tokyo (JP); Hisako Taguchi, Tokyo (JP)

(73) Assignee: NOMURA RESEARCH INSTITUTE, LTD., Tokyo (JP)

(21) Appl. No.: 15/821,190

(22) Filed: Nov. 22, 2017

Related U.S. Application Data
(63) Continuation of application No. PCT/JP2015/065148, filed on May 26, 2015.

(51) Int. Cl. G06Q 40/04

(52) U.S. Cl. CPC G06Q 40/04; G06Q 40/06

(57) ABSTRACT

A securities trading management system capable of automating processing related to post-trade operations as well as performing the processing ahead of schedule in accordance with circumstances is provided. The securities trading management system according to a typical embodiment includes: one or more buy side systems including a buy side order management system; one or more sell side systems including a sell side order management system; and a post-trade service providing system that provides each of the sell side systems with at least a part of the post-trade processing as a service. The post-trade service providing system automatically conducts at least the part of the post-trade processing of the order from the buy side based on one or more processing patterns of the post-trade processing on the sell side set in advance for each of the sell sides.

### CROSS-REFERENCE TO RELATED APPLICATIONS

This application is a continuation application, under 35 U.S.C. § 111(a), of international application No. PCT/JP2015/065148, filed May 26, 2015, the contents of which are incorporated herein by reference

### TECHNICAL FIELD

The present invention relates to a technique for securities trading, and more particularly, relates to a technique effectively applied to a securities trading management system that handles post-trade operations after trade is established.

### BACKGROUND ART

A securities company (sell side) has operations that accept a large quantity of orders for valuable securities trading from an asset management company (buy side) such as an institutional investor and that actually deal the trading through a market or others. Such operations are generally managed and handled by an information processing system.

For example, Japanese Patent Application Laid-Open Publication No. 2002-358414 (Patent Document 1) discloses a system that shortens a period of time from order execution to settlement by performing a trade-execution processing to execute an order in response to a request for ordering valuable securities from an institutional investor system, by sending a trade-execution result to the institutional investor system, by sending the trade-execution result to a settlement matching system to report buying/selling trading, by encouraging the matching of the trade-execution, by instructing the settlement matching system to settle the trade-execution, a matching result of which has been received from the settlement matching system, by encouraging the matching for the settlement instruction, and by instructing a settlement institution system to transfer the settlement, the matching result for the instruction of which has been received from the settlement matching system.

Further, Japanese Patent Application Laid-Open Publication No. 2003-233718 (Patent Document 2) describes a system capable of efficiently and quickly matching the trade-execution and the settlement as well as capable of easily checking a progress of the processing by bi-directionally converting and exchanging data of communications on the trade-execution of the valuable securities between a plurality of trading partners and a management device through different data communication systems and by managing a change of the trade-execution status.

Further, as a system on the institutional investor side (buy side), for example, Japanese Patent Application Laid-Open Publication No. 2005-228029 (Patent Document 3) describes an order management system that manages an order of stocks from the institutional investor to a securities company, the system matching the order data with the trade-execution result data from the securities company, extracting any order that has not been executed within a predetermined period of time from the purchase order time, and sending the order cancellation data of such orders.

### RELATED ART DOCUMENTS

### Patent Documents

Patent Document 1: Japanese Patent Application Laid-Open Publication No. 2002-358414

Patent Document 2: Japanese Patent Application Laid-Open Publication No. 2003-233718

Patent Document 3: Japanese Patent Application Laid-Open Publication No. 2005-228029

### SUMMARY OF THE INVENTION

### Problems to be Solved by the Invention

Each of the sell side and the buy side performs trading operations such as conduction of the order acceptance/placement and the management of the trade execution, and besides, so-called post-trade operations as post-execution processes such as trade allocation to each account on the buy side, calculation of charges for service or others, matching, and settlement of funds and securities.

Here, a rule and a method in the processing for, for example, the allocation to the account, the calculation of the charges for service, and others, are different for each of the buy sides. Particular, Japanese asset management companies use a special pattern in the rule and the method in many cases. Regarding this point, although the buy side can handle the point by using a system and others that is individualized so as to handle an in-house rule and others, the sell side which deals with a plurality of buy sides as customers currently handles the point by individually handling each of the buy sides through a large scale mobilization of labor with many manpower. Further, since the post-trade operations are usually performed after the closing of sessions, a processing time is strictly limited, and the operations are handled by manpower in order to perform the processing in a short time.

Therefore, an object of the present invention is to provide a securities trading management system capable of automating processing for the post-trade operations as well as performing the processing ahead of schedule in accordance with circumstances.

The above and other object and novel characteristics of the present invention will be apparent from the description of the present specification and the accompanying drawings.

### Means for Solving the Problems

The summary of the typical aspects of the inventions disclosed in the present application will be briefly described as follows.

A securities trading management system according to a typical embodiment of the present invention is a securities trading management system that manages securities trading performed by a sell side after receiving an order from a buy side, and it includes: one or more buy side systems including a buy side order management system managing an order to the sell side on the buy side; one or more sell side systems including a sell side order management system managing the order from the buy side on the sell side; and a post-trade service providing system providing at least a part of post-trade processing to each of the sell side systems for each of the sell sides as a service. The post-trade service providing system automatically performs at least the part of the post-trade processing for the order placed by the buy side based on one or more processing patterns of the post-trade processing on the sell side, the processing pattern being previously set for each of the sell sides.

### Effects of the Invention

The effects obtained by the typical aspects of the present invention will be briefly described below.

That is, according to the typical embodiment of the present invention, the processing for the post-trade operations can be automated, and besides, the processing can be performed ahead of schedule in accordance with circumstances, so that an operational load on the post-trade operations can be reduced, and the processing time can be shortened.

### BRIEF DESCRIPTIONS OF THE DRAWINGS

FIG. 1 is a diagram illustrating an outline of a configuration example of a securities trading management system according to one embodiment of the present invention;

FIG. 2 is a diagram illustrating an outline of a flow example of operation processing for a trade performed between a buy side and a sell side according to one embodiment of the present invention;

FIG. 3 is a diagram illustrating an outline of a method example of the post-trade processing on the sell side according to one embodiment of the present invention;

FIG. 4 is a diagram illustrating an outline of a method example for equalization of daytime processing and automation of the post-trade processing according to one embodiment of the present invention;

FIG. 5 is a diagram illustrating an outline of an example of automation attribute and setting contents that can be specified at the time of setting a processing pattern according to one embodiment of the present invention;

FIG. 6 is a diagram illustrating an outline of a setting example of a processing pattern for each process according to one embodiment of the present invention;

FIG. 7 is a diagram illustrating an outline of a flow example of matching processing performed between the buy side and the sell side according to one embodiment of the present invention;

FIG. 8 is a diagram illustrating an outline of a flow example of operation processing for a trade performed between a buy side and a sell side according to a related art; and

FIG. 9 is a diagram illustrating an outline of a method example of post-trade processing on the sell side according to the related art.

### BEST MODE FOR CARRYING OUT THE INVENTION

Hereinafter, embodiments of the present invention will be described in detail, based on the accompanying drawings. Note that the same components are denoted by the same reference symbols throughout all the drawings for describing the embodiments in principle, and the repetitive description thereof will be omitted. On the other hand, although a portion with a reference symbol described in a certain drawing is not illustrated again for the description of other drawings, the portion is described with the same reference symbol. Also, the following description is made in comparison with the related art for easily understanding the features of the present invention.

<Outline>

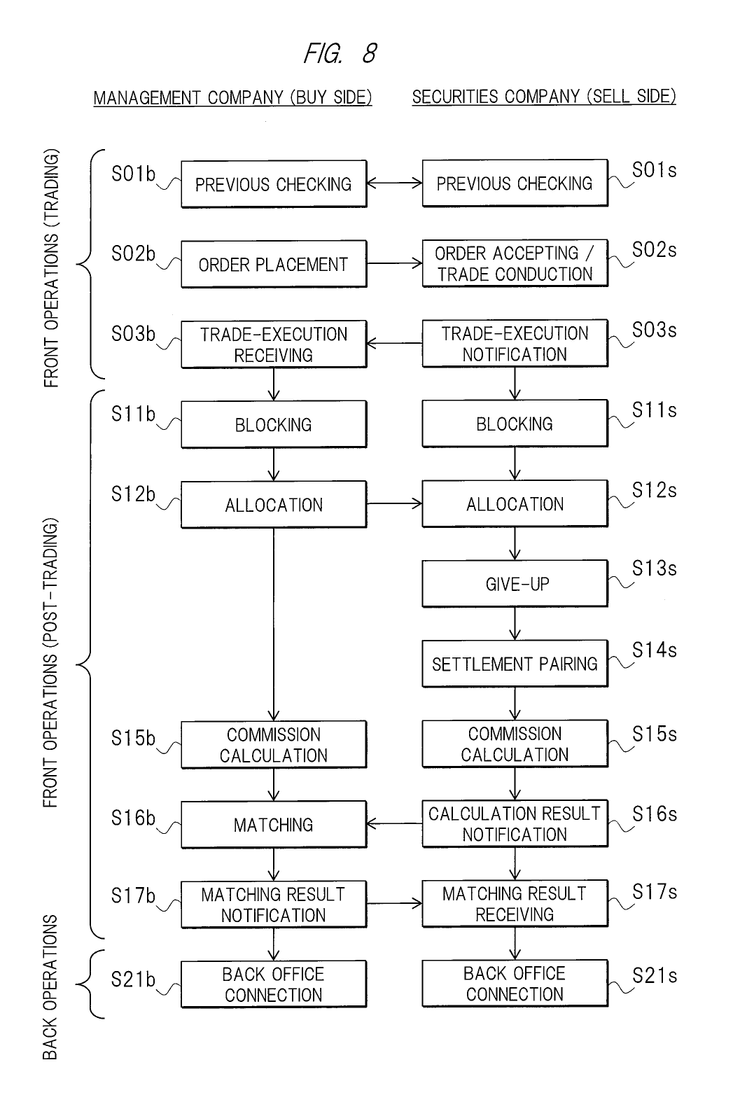

FIG. 8 is a diagram illustrating an outline of a flow example of operation processing for a trade performed between a buy side and a sell side according to a related art. It is assumed that each of a management company (buy side) and a securities company (sell side) performs operations appropriately using an individual information processing system such as an order management system. During a continuous session in the daytime, trading processing is performed as a front office operation. Here, after a previous check (S01b, S01s) is made between the management company (buy side) and the securities company (sell side), the buy side places an order (S02b) and sends order data to the sell side. In response to the order data, the sell side accepts the order and executes the order on an exchange (S02s). Then, when the trade is executed, the sell side issues a notification of the fill (S03s), and the buy side receives the execution report (S03b).

After close of the session, the post-trade processing of the front office operations is performed. Here, both of the buy side and the sell side perform blocking processing (S11b, S11s) by taking in the trade-execution data for blocking (narrowing of spread) , and then, the buy side creates instruction data on account allocation of the order and the trade execution (S12b), and sends the data to the sell side. The sell side receives the allocation data, and performs the allocation so as to allocate an amount of the trade execution to a clearing account on the buy side (an account of a customer for the buy side) based on the instruction (S12s).

The sell side further performs processing such as give-up processing that performs clearing and settlement of the executed trade at a different securities company (S13s) or pairing of settlement of reverse trading in futures trading (S14s), and then, calculates a commission and a tax (S15s), and notifies the buy side of a calculation result (S16s). The buy side also calculates the commission and the tax (S15b), and matches its calculation result with the calculation result on the sell side that has been sent from the sell side (S16b). The sell side is notified of a matching result from the buy side (S17b, S17s). The front office operations are completed in a series of processing described above. Then, as back office operations, systems on the buy side and on the sell side are connected to back office systems, respectively, and perform the settlement processing and others.

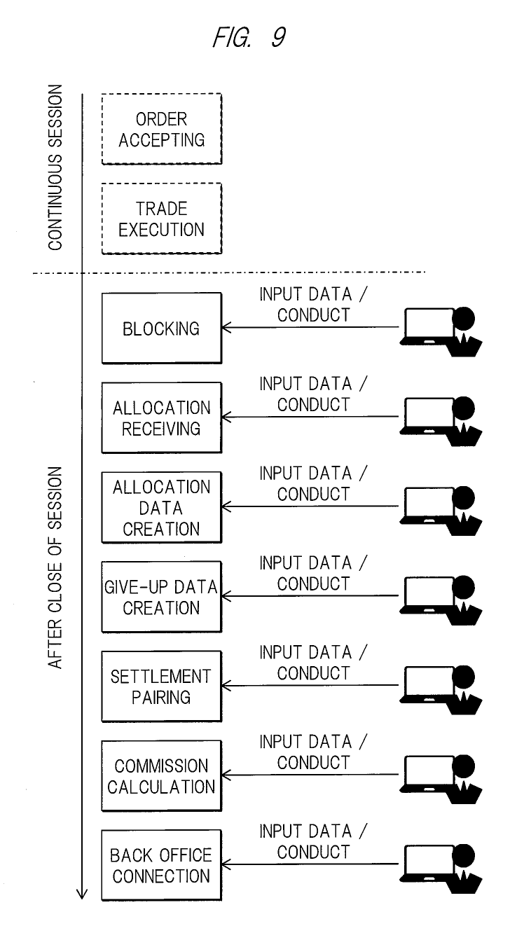

FIG. 9 is a diagram illustrating an outline of a method example of the post-trade processing on the sell side according to the related art. As illustrated in the drawing, currently, although each processing including the post-trade processing is performed through the information processing system, the processing is performed by manual data input and manual operation, and therefore, it is difficult to automate the processing. For example, regarding the allocation, the sell side cannot perform the allocation in some cases because the sell side cannot recognize the number of accounts that are destinations of the allocation and others from only the order information and the fill information of the trade execution received by the sell side. Further, even when the sell side recognizes the information on the account, if there is such irregular processing that the trades for all orders have not been executed, the sell side cannot perform the allocation without an instruction of the allocation from the buy side in some cases. In a state in which the allocation is impossible, the calculation for the commission and the tax is impossible, either.

As described above, in addition to the processing that involves human decision, a rule and a pattern of processing are different for each of the buy sides in many cases, and there are many circumstances under which an individual handling is required for each of the buy sides. Furthermore, since it is required to perform a large amount of works including creation of report information and others in a short time after the close of the session, the post-trade processing is handled through a large scale mobilization of labor with many manpower.

Therefore, in a securities trading management system according to one embodiment of the present invention, a/some units related to the post-trade processing in the information processing system owned by each of the sell sides is configured on a common platform, and can be commonly coordinated by the information processing system owned by each of the buy sides. Accordingly, the post-trade processing can be automated on both sides, and an operation cost and processing time caused by the manpower can be reduced. Furthermore, when the allocation data can be received at an early stage such as at the time of order placement, the time for the post-trade processing after the close of the session can be further reduced by previously sorting the orders even before the close of the session. Furthermore, efficiency of the processing related to communications in a case of unmatching of the calculation result between the buy side and the sell side is enhanced.

<System Configuration>

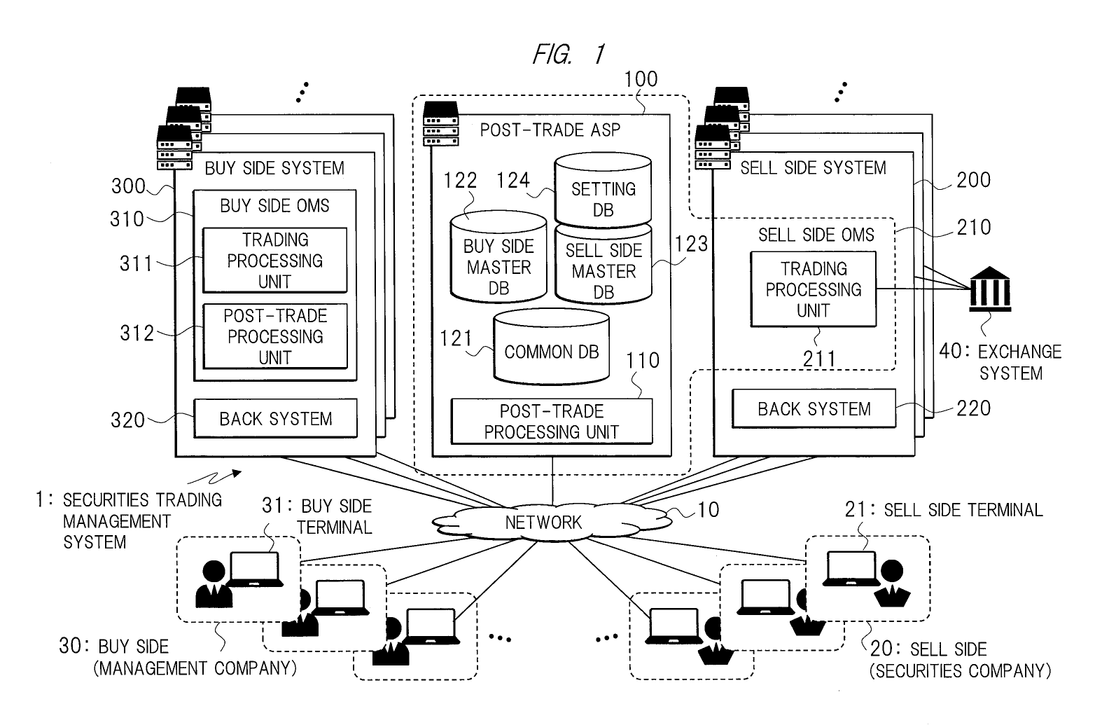

FIG. 1 is a diagram illustrating an outline of a configuration example of the securities trading management system according to one embodiment of the present invention. A securities trading management system 1 has a configuration in which information processing systems such as a plurality of buy side systems 300, a plurality of sell side systems 200, and a post-trade ASP 100 are connected to a network 10 such as the Internet. Each of the buy side systems 300 is the information processing system including an order management system owned by each of the buy sides 30 (e.g. management company) and others, and each of the sell side systems 200 is the information processing system including an order management system owned by each of the sell sides 20 (e.g. securities company) and others.

The post-trade ASP 100 is the information processing system that provides the buy sides 30 and the sell sides 20 with a support service related to the operation of the post-trade processing as a common platform by an ASP (application service provider). While the present embodiment has such a configuration that the common platform is provided as an ASP service, it also has such a configuration that each of the buy side systems 300 and each of the sell side systems 200 individually has the common platform in an on-premises type configuration.

A person in charge on each of the sell sides 20 or others accesses the sell side system 200 of his/her own company by using a not-illustrated Web browser of a sell side terminal 21 or others, the terminal being an information processing terminal used by himself/herself, and performs operations as the sell side 20. Similarly, a person in charge on each of the buy sides 30 or others accesses the buy side system 300 of his/her own company by using a not-illustrated Web browser of a buy side terminal 31 or others, the terminal being an information processing terminal used by himself/herself, and performs operations as the buy side 30.

Each of the systems described above is implemented by, for example, one or more server devices, a virtual server constructed on a cloud computing service, or others. From a viewpoint of enabling information sharing between the buy side 30 and the sell side 20, it is desirable to manage and monitor each of the systems by, for example, the same IT service provider, but the present invention is not limited to this configuration.

The sell side system 200 includes, for example, a trading processing unit 211 implemented as software which operates on an operating system (OS), a database management system (DBMS), and a middleware such as a Web server program although not illustrated. It also includes a back system 220 that is a back office system.

The trading processing unit 211 constitutes a part of a sell side OMS 210 which is an order management system (OMS) on the sell side 20 in the sell side system 200, and it performs a trading processing of the front operations. It also has a function to execute the online buying/selling order to a stock exchange such as the Tokyo Stock Exchange through the network 10 or others. In the sell side OMS 210, it is assumed that the post-trade processing of the front operations is offered as an ASP service by accessing the post-trade ASP 100.

The post-trade ASP 100 includes, for example, a post-trade processing unit 110 implemented as a software which operates on an OS, a DBMS, and a middleware such as a Web server program although not illustrated. It also includes each of data stores such as a common database (DB) 121, a buy side master DB 122, a sell side master DB 123, and a setting DB 124, which are implemented by a database, a file table, or others.

The post-trade processing unit 110 offers a service related to the post-trade processing of the front operations. Here, various types of the post-trade processing such as the above-described blocking, allocation, give-up, settlement pairing, the calculation of the commission, and the result matching are performed based on contents set by each of the sell sides 20 and various types of information on the buy sides 30 obtained from the buy side system 300.

The common DB 121 is a table that stores the sharable data such as data, disclosure of which has been accepted, between the sell side system 200 and the buy side system 300. By referring to the data, the processing can be efficiently coordinated between the sell side system 200 and the buy side system 300, and can be automated. It is obvious to allow the information exchange between the buy side system 300 and the sell side system 200 by directly sending and receiving the data without using the common DB 121.

The buy side master DB 122 and the sell side master DB 123 are tables that store master information of the buy side 30 and the sell side 20 to which the support service for the post-trade processing can be offered by the access to the post-trade ASP 100, respectively. The information may also include account information of a user. The setting DB 124 is a table that stores various pieces of the setting information such as a processing condition and a processing pattern definition in the post-trade processing for each of the sell sides 20. The table may also store the setting information different for each of the buy sides 30.

The buy side system 300 includes, for example, a buy side OMS 310 which is an order management system on the buy side 30, and a back system 320 which is a back office system. The buy side OMS 310 includes various units such as a trading processing unit 311 and a post-trade processing unit 312 implemented as software that although not illustrated.

The trading processing unit 311 performs the trading processing of the front operations on the buy side 30. Further, the post-trade processing unit 312 performs the post-trade processing on the buy side 30. Through the access to the post-trade ASP 100, the post-trade processing can be also coordinated by the sell side 20 in the matching processing.

<Overall Processing Flow>

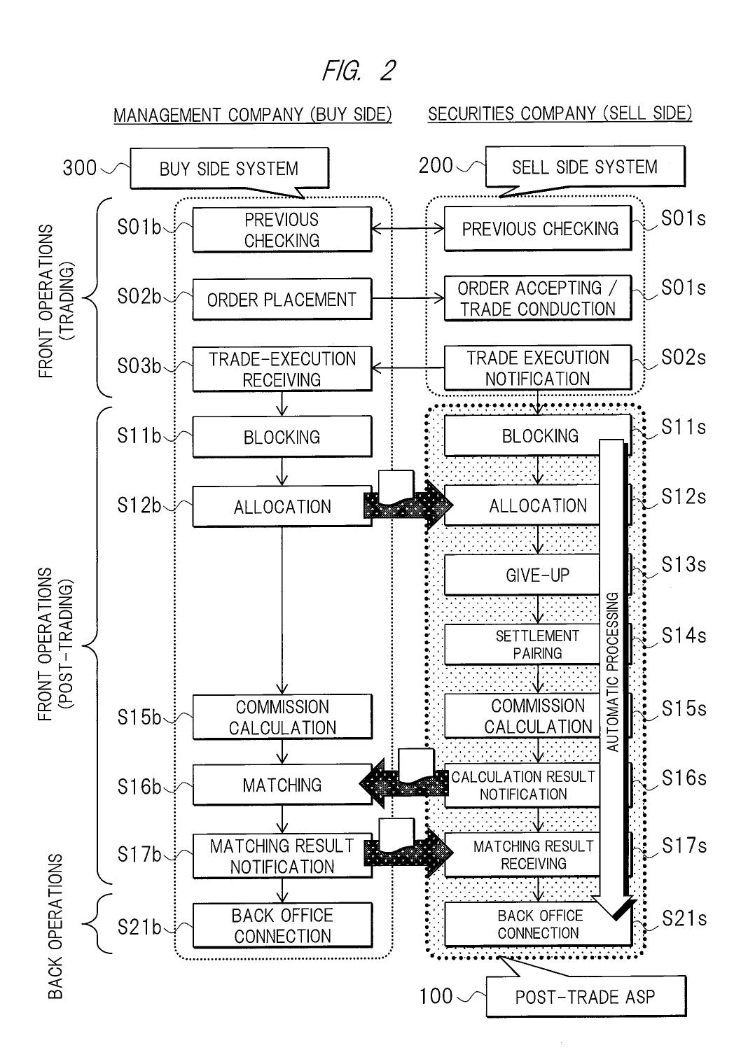

FIG. 2 is a diagram illustrating an outline of a flow example of operation processing related to the trade performed by the buy side and the sell side according to the present embodiment. In the present embodiment, basically, the processing on the buy side 30 is performed by the buy side system 300, and the processing on the sell side 20 is performed by the sell side system 200. However, as different from the example of the related art illustrated in FIG. 8, the post-trade processing on the sell side 20 is performed by the post-trade ASP 100, and a series of the post-trade processing up to the matching of the calculation results of the commission and the tax is automated.

Here, as illustrated in the drawing, the buy side system 300 coordinates the allocation data with the post-trade ASP 100 at timing of completion of the allocation. The coordination may be made by a method of sending the data or a method of registering the data to the common DB 121. The sell side system 200 automatically performs a series of processing from the blocking (S11s) to the calculation of the commission (S15s) based on the processing pattern, rule, and others which have been previously set and registered in the setting DB 124 for each of the sell sides 20. At that time, by referring to the order data and the trade-execution data obtained from the sell side system 200, the allocation data obtained from the buy side system 300, and others, the sell side system automatically selects the processing pattern in accordance with the contents of the data, and performs the processing based on the processing pattern.

Then, the exchange of the calculation result of the commission, the matching by the buy side system 300, and the exchange of the matching result can be automatically coordinated by the post-trade ASP 100 and the buy side system 300.

<Post-Trade Processing>

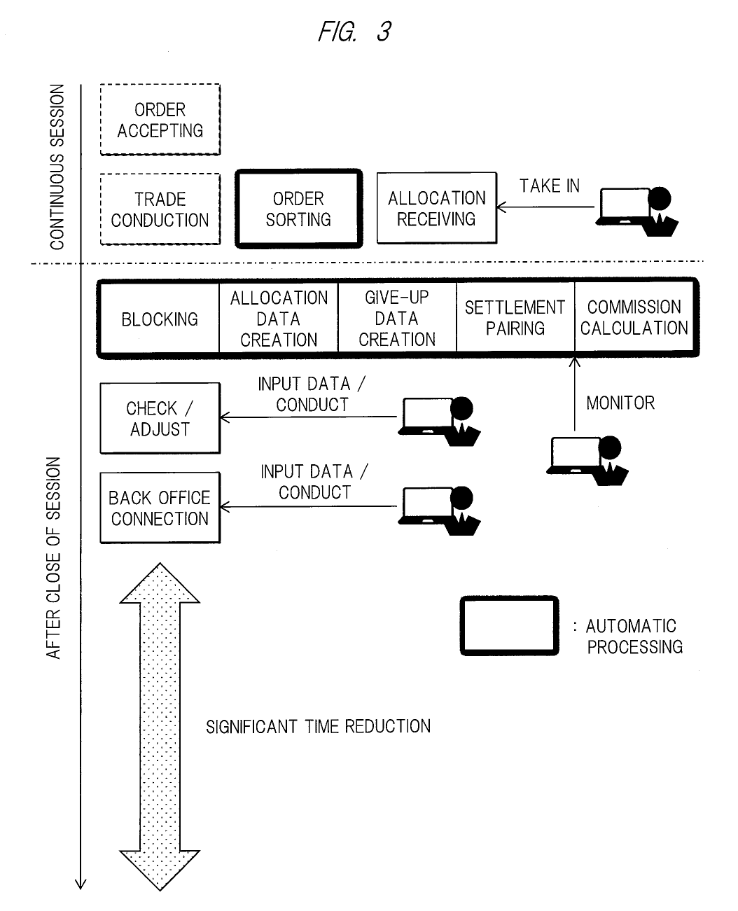

FIG. 3 is a diagram illustrating an outline of a method example of the post-trade processing on the sell side 20 according to the present embodiment. As different from the example of the related art illustrated in FIG. 9, the present embodiment offers the automation processing on the post-trade ASP 100 for the processing such as the blocking, the allocation, the give-up, the settlement pairing, and the calculation of the commission, for which the data input and the conduction are manually performed in the post-trade processing after the close of the session. Therefore, a user only needs to monitor the conduction and to check and adjust a processing result, and therefore, significant reduction of a workload and reduction of a work time can be achieved.

Note that the allocation data from the buy side system 300 is received not only after the close of the session, but also during the continuous trading session before the close of the session and is taken in the post-trade ASP 100 ahead of schedule as illustrated in FIG. 3 when, for example, an account is already determined at the time of the order placement from the buy side 30 or the account is determined before the close of the session. Accordingly, the processing time of the post-trade processing can be further reduced.

Further, as the automatic conduction of the post-trade processing after the close of the session, basically, processing to sort the orders is performed after the trade execution based on the order contents from the buy side 30, and the post-trade processing is performed based on the processing pattern corresponding to each sorted order.

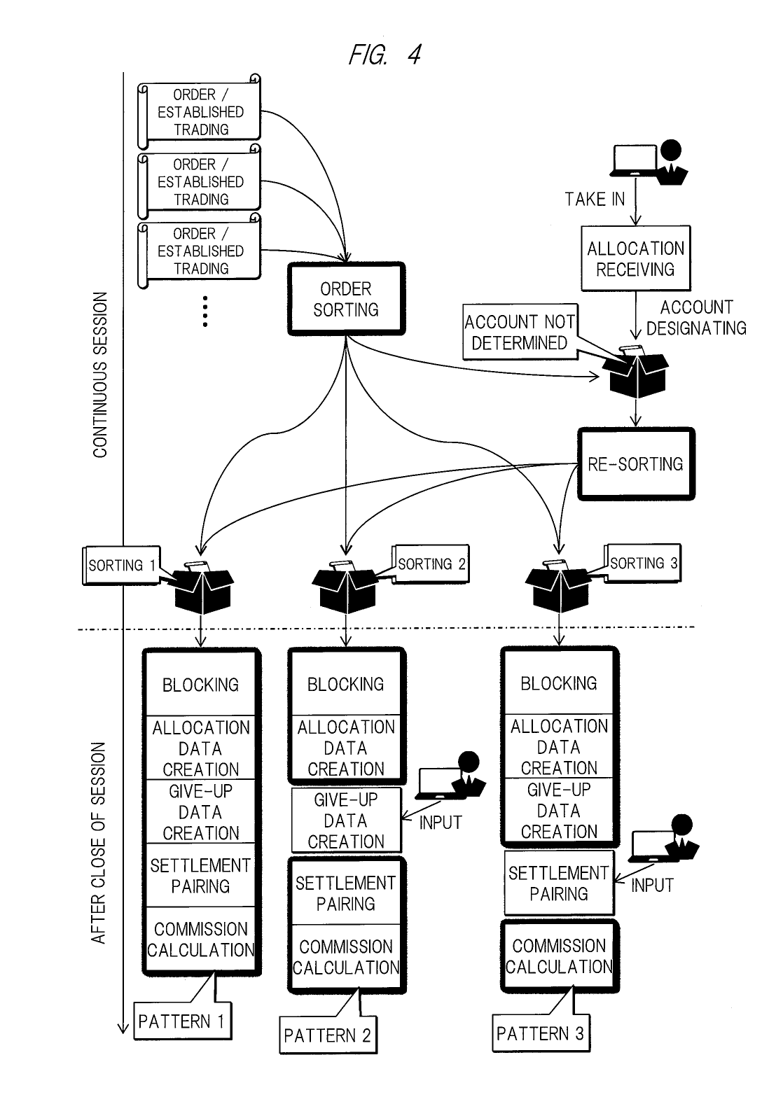

FIG. 4 is a diagram illustrating an outline of a method example of leveling a processing during the continuous session and automatically conducting the post-trade processing. The post-trade processing unit 110 of the post-trade ASP 100 obtains the executed order data and the fill data from the trading processing unit 211 of the sell side system 200 at any time in the continuous trade session of the trading day, and the post-trade processing unit sorts the orders in accordance with a combination of an attribute of the buy side 30 and an attribute of an issue and in accordance with information indicating whether the clearing account information for the order is determined or not. The example of FIG. 4 shows a case of the sorting into three patterns of “Sorting 1”, “Sorting 2”, and “Sorting 3”. If the account information is not determined at the time of the order placement, the order is sorted into an “undetermined account (default)”. The order that has been sorted into this pattern is resorted later at the time of the reception of the allocation data from the buy side system 300 followed by the taking-in of the data, based on account specification. Therefore, the post-trade processing is suspended until the resorting is performed.

Each sorted order is automatically processed in accordance with the processing pattern corresponding to each of the sorting patterns in the post-trade processing after the close of the session. The example of FIG. 4 shows that the order is automatically processed in three processing patterns that are “Pattern 1”, “Pattern 2”, and “Pattern 3” corresponding to the three sorting patterns that are “Sorting 1”, “Sorting 2”, and “Sorting 3”, respectively. In the present embodiment, the processing performed in the post-trade operations is roughly classified into five processes that are “blocking”, “allocation data creation”, “give-up data creation”, “settlement pairing”, and “commission calculation”, and the processing patterns can be previously set by combining the processing contents of each of the processes.

The “Pattern 1” in the drawing shows a case of, for example, the buy side which performs typical processing and simple processing for all of five processes from the blocking to the commission calculation. In this case, all of the five processes can be automatically processed based on a previously-determined processing procedure. The “Pattern 2” shows a case of, for example, the buy side which has a complicated rule only for selecting and determining an alternative securities company in the give-up processing. In this case, only the “give-up data creation” is input and conducted by a person in charge of the sell side 20, and other processes can be automatically conducted by a previously-determined processing procedure.

The “Pattern 3” shows a case of, for example, the buy side which performs the settlement based on designation of a position. In this case, only the “settlement pairing” for pairing with the position that has been designated at the time of the settlement is input and conducted by the person in charge of the sell side 20, and other processes can be automatically conducted by a previously-determined processing procedure. In this manner, by previously determining the processing pattern obtained by appropriately combining the automatic conduction and the manual conduction for each process of the post-trade processing, the automatic processing can be flexibly set in accordance with the characteristics of the buy side 30.

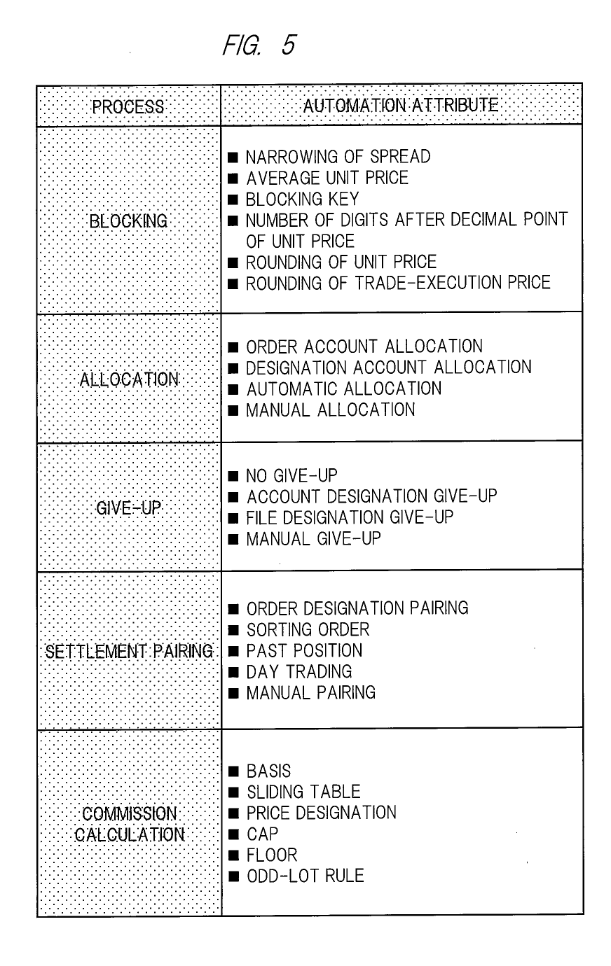

FIG. 5 is a diagram illustrating an outline of an example of automation attribute that can be designated at the time of setting of the processing pattern for each of the processes. An “automation attribute” column in the drawing indicates an example of an attribute item that is necessary to be set to define the processing pattern of the automatic processing. For example, in the blocking processing, the automation attribute includes “narrowing of spread” and “blocking key”, and therefore, it means that the blocking processing can be automated in accordance with the setting contents of the “narrowing of spread” and the “blocking key”. Similarly, for example, in the allocation processing, the automation attribute includes “automatic allocation” and “manual allocation”, and therefore, it means that the allocation can be automated in accordance with the setting contents of them. The same goes for other processes such as the give-up data creation, the settlement pairing, the commission calculation and others.

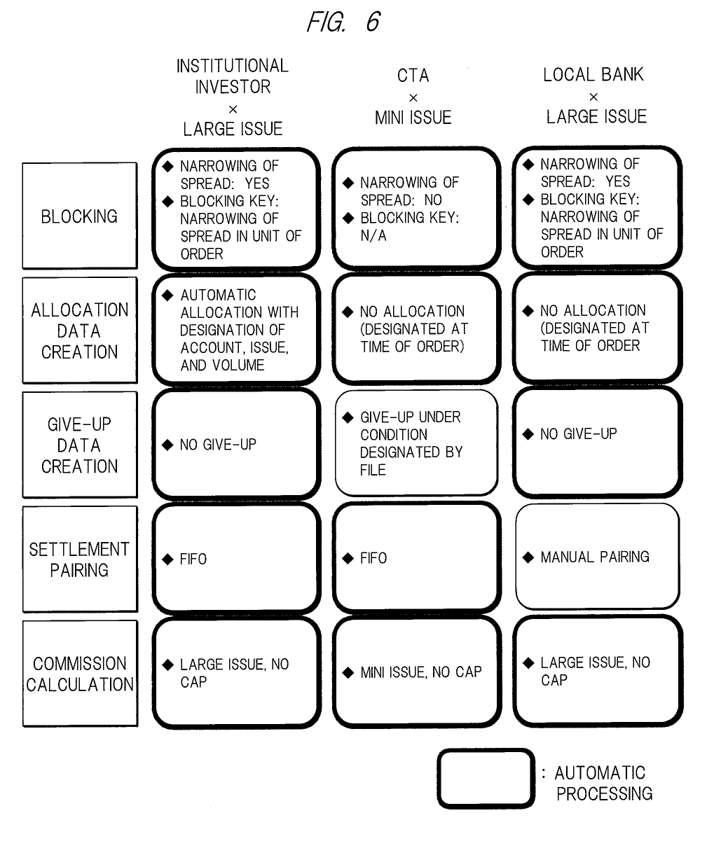

FIG. 6 is a diagram illustrating an outline of a setting example of the processing pattern for each of the processes. Here, an example of setting the processing pattern for each attribute combination of the “buy side x issue” is shown. For example, when the buy side 30 is an “institutional investor” and the issue is a “large issue” (“institutional investor×large issue” in the drawing), it means that a series of processes is automatically conducted based on a pattern having a logic that is previously set in accordance with the illustrated contents.

And, when the buy side 30 is a “commodity trading advisor (CTA)” and the issue is a “mini issue” (“CTA×mini issue” in the drawing), a processing pattern including such a manual operation as to perform the give-up under a condition designated by a file from the buy side 30 is set in the give-up data creation, and it means that the automatic processing is temporarily suspended at this time. Similarly, when the buy side 30 is a “local bank” and the issue is a “large issue” (“local bank×large issue” in the drawing), such a processing pattern as to manually perform the pairing is set in the settlement pairing, and it means that the automatic processing is temporarily suspended at this time. In the examples described above, note that the orders are sorted based on the combination of the attributes of the buy side 30 and the issue (“buy side×issue”). However, a combination of other items such as an order type may be also used.

In this manner, in the post-trade ASP 100, the orders are automatically sorted based on the attribute information of the buy side 30 and the order, and the post-trade processing is automated in accordance with the processing pattern that is previously determined in terms of the sorting, so that the operation cost and the processing time can be significantly reduced.

<Matching Processing>

In the post-trade processing, the commission and the tax are calculated by both of the buy side 30 and the sell side 20, and the buy side 30 performs the operation for the matching of the calculation result. If the matching is succeeded (the matching), there is no particular problem. However, if the matching is failed (the matching braking), this leads to increase in office works for checking a cause of the matching failure, increase in the communications between the buy side 30 and the sell side 20, and others, as well as to decrease in evaluation of an office work performance of the sell side 20 in some cases. Thus, there are such needs on the sell side 20 as to improve an efficiency of the matching processing and to perform quick correction and recalculation in the case of the matching break without the awareness of the buy side 30.

Therefore, in the present embodiment, in the case of the matching break on the buy side 30, notification of the matching break is not displayed on a screen of the buy side system 300, in other words, not the buy side 30 but only the post-trade ASP 100 is notified of the matching break. Accordingly, on the post-trade ASP 100, the sell side 20 can quickly check the matching result and perform the recalculation without the awareness of the buy side 30.

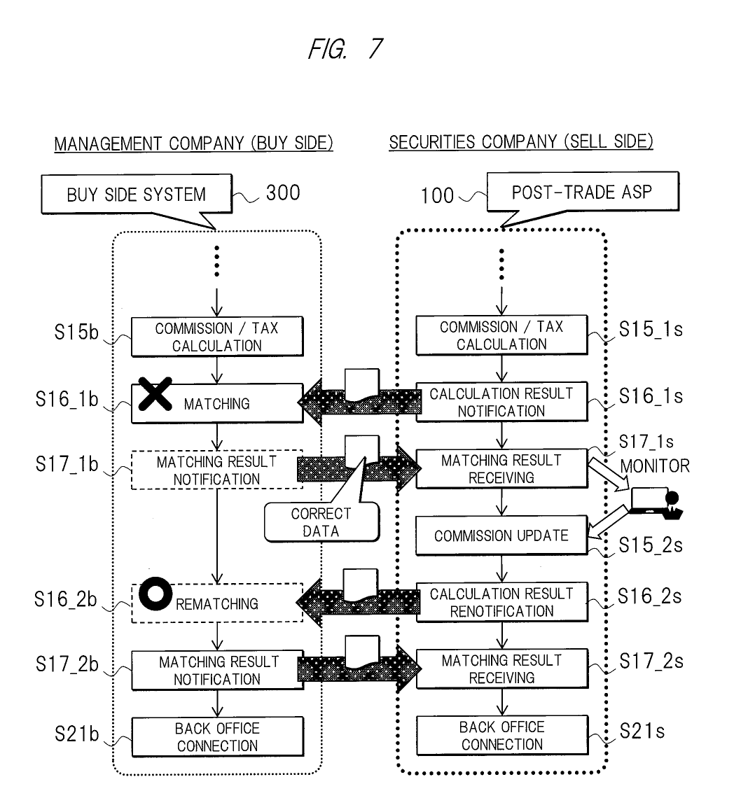

FIG. 7 is a diagram illustrating an outline of a flow example of the matching processing performed between the buy side and the sell side according to the present embodiment. In the present embodiment, as described above, by storing the rules for the allocation and the commission calculation for each of the buy sides 30 in the setting DB 124 in the post-trade ASP 100, the sell side 20 can also automate the processing of the commission calculation.

When the processing up to the commission calculation (S15b, S15_1s) is performed by the same processing as that of the flow of the processing illustrated in FIG. 2 in each of the buy side system 300 and the post-trade ASP 100 of the sell side 20, notification of the calculation result is provided from the post-trade ASP 100 (S16_1s), and the matching processing (S16_1b) is performed in the buy side system 300. At this time, if the matching result is failed (matching break), the notification is not displayed on a screen of the buy side system 300, in other words, only the post-trade ASP 100 is notified of the matching break without the awareness of the buy side 30 (S17_1b). At this time, data on a result of the commission calculation on the buy side 30, that is, “correct data” of the matching on the buy side 30 is also sent in addition to the matching result.

The post-trade ASP 100 monitors the reception of the matching result (S17_1s), and notifies the person in charge or others on the sell side 20 by a message on the screen or others if there is the matching break. The person in charge checks contents of unmatching items in the matching result, and updates the commission (S15_2s). If there is no problem in contents of the calculation result (“correct data”) on the buy side 30, the result can be also accepted as it is.

The buy side system 300 is notified of the recalculation result again (S16_2s), and the matching of the recalculation result is checked again on the buy side system 300 (S16_2b). The matching at this stage is also automatically performed without the awareness of the buy side 30. The calculation result sent from the post-trade ASP 100 is basically based on the “correct data” on the buy side 30, and therefore, the re-matching is succeeded (the matching). Then, the matching result is sent from the buy side system 300 to the post-trade ASP 100 (S17_2b, S17_2s). If the matching result shows the matching, the processes up to a back office connection can be automatically performed (S21b, S21s).

When the matching in the calculation result between the buy side 30 and the sell side 20 shows the matching break as described above, the notification, the recalculation, and the re-matching can be performed without the awareness of the buy side 30. Accordingly, the office works in the matching break related to the notifications and the communications between the buy side 30 and the sell side 20 can be significantly reduced so as to improve efficiency of the processing, and an influence on the evaluation of the sell side 20 caused by the awareness of the buy side 30 about the occurrence of the matching break can be removed.

If it is determined that the calculation result of the sell side 20 is correct when the post-trade ASP 100 receives the matching break result from the buy side system 300 and checks the contents of the result, note that a notification of the determination (“break disclosure notice”) may be sent to the buy side system 300 so as to open the occurrence of the matching break and make the buy side 30 be aware of the occurrence of the matching break. In this case, for example, the buy side system 300 can take in the calculation result data of the sell side 20, and perform the matching processing again.

Further, as illustrated in the example of FIG. 7, in order to enable the commission calculation and the matching individually to both of the buy side system 300 and the post-trade ASP 100, both of the systems have such preconditions as storing the rules for the commission calculation and the data used for the calculation in each of the systems or as having a configuration in which the rules and the data are shared in the common DB 121 on the post-trade ASP 100 or others.

In the foregoing, the invention made by the present inventors has been concretely described based on the embodiments. However, it is needless to say that the present invention is not limited to the foregoing embodiments and various modifications and alterations can be made within the scope of the present invention. For example, the above-described embodiments have been explained in detail for easily understanding the present invention, but are not always limited to the one including all structures explained above. Further, the other structure can be added to/eliminated from/replaced with a part of the structure of the embodiments.

### INDUSTRIAL APPLICABILITY

The present invention is applicable to a securities trading management system that handles post-trade operations after a trade is established.

### EXPLANATION OF REFERENCE CHARACTERS

1 . . . securities trading management system,
10 . . . network, 20 . . . sell side, 21 . . . sell side terminal, 30 . . . buy side, 31 . . . buy side terminal, 40 . . . exchange system,
100 . . . post-trade ASP, 110 . . . post-trade processing unit, 121 . . . common DB, 122 . . . buy side master DB, 123 . . . sell side master DB, 124 . . . setting DB,
200 . . . sell side system, 210 . . . sell side OMS, 211 . . . trading processing unit, 220 . . . back system,
300 . . . buy side system, 310 . . . buy side OMS, 311 . . . trading processing unit, 312 . . . post-trade processing unit, 320 . . . back system

1. A securities trading management system that manages securities trading performed by a sell side after receiving an order from a buy side, comprising:
one or more buy side systems including a buy side order management system managing an order to the sell side on the buy side;
one or more sell side systems including a sell side order management system managing an order from the buy side on the sell side; and
a post-trade service providing system providing at least a part of post-trade processing to each of the sell side systems for each of the sell sides as a service,
wherein the post-trade service providing system obtains, from the sell side system, information of an executed order from the buy side, sorts the obtained information of each order into one or more classifications before close of a session based on a combination of the attribute information including attribute information of the buy side having placed the order and attribute information of an issue related to the order, and automatically performs at least the part of the post-trade processing for the order from the buy side based on one or more processing patterns obtained by combination in automatic execution and manual execution among processes of the post-trade processing on the sell side, the processing pattern being previously set to each of the classifications for each of the sell sides.

2. The securities trading management system according to claim 1,
wherein the post-trade service providing system obtains, from the buy side system, account allocation information related to the order placed by the buy side, and performs account allocation processing of the post-trade processing on the sell side based on the account allocation information.

3. The securities trading management system according to claim 2,
wherein, before close of a session, the post-trade service providing system obtains the account allocation information from the buy side system.

4. The securities trading management system according to claim 2,
wherein, when the information of each order obtained from the sell side system is sorted, if the account allocation information has not been obtained from the buy side system of the buy side having placed the order, the post-trade service providing system sorts the information of the order into a predetermined classification, and suspends the post-trade processing, and then, resorts the information again when the account allocation information is obtained later.

5. The securities trading management system according to claim 1,
wherein the post-trade service providing system stores information related to a rule for calculating a commission for each of the buy sides, calculates the commission related to the order based on the rule in the post-trade processing, and sends a result of the calculation to the buy side system, and
the buy side system checks whether or not a commission calculated by the buy side system matches the commission received from the post-trade service providing system.

6. The securities trading management system according to claim 5,
wherein, if the matching is failed as a result, the buy side system sends information of the result of the matching to the post-trade service providing system without outputting the information to the buy side system, and
the post-trade service providing system updates the commission based on the information of the result of the matching received from the buy side system, and resends updated information to the buy side system.
